(19) United States
(12) Patent Application Publication
(10) Pub. No.: US 2023/0042188 A1
(43) Pub. Date: Feb. 9, 2023

(54) CIGARETTE PREPARATION DEVICE

(71) Applicant: Asaf RAHAMIM, Or Yehuda (IL)

(72) Inventor: Asaf RAHAMIM, Or Yehuda (IL)

(21) Appl. No.: 17/789,945

(22) PCT Filed: Jan. 30, 2021
(86) PCT No.: PCT/IL2021/050109

§ 371 Date: Jun. 29, 2022

Related U.S. Application Data
(60) Provisional application No. 62/968,178, filed on Jan. 31, 2020.

(51) Int. Cl. A24C 5/44; B02C 18/24

(52) U.S. Cl. CPC A24C 5/44; B02C 18/24

(57) ABSTRACT

The present subject matter provides a cigarette preparation device including: a chopping module configured to chop smoke material for preparing chopped smoke material; and a rolling module coupled to the chopping module, configured to roll cigarettes with cigarette paper and chopped smoke material. Additional embodiments of the cigarette preparation device, and methods for chopping a smoke material, rolling a cigarette, and preparing a cigarette with the cigarette preparation device of the present subject matter, are described herein.

### CROSS-REFERENCE TO RELATED APPLICATION

This application claims priority to U.S. Provisional Patent Application No. 62/968,178, filed Jan. 31, 2020, the entire contents of which is incorporated herein by reference in its entirety.

### FIELD

The present subject matter relates to smoking accessories. More particularly, the present subject matter relates to personal devices for self-preparation of cigarettes.

### BACKGROUND

Recently there is an increasing tendency to self-prepare cigarettes instead of consuming ready-to-use cigarettes, especially because of a desire of cigarette consumers to prepare self-tailored cigarettes according to their taste and needs. Thus, cigarette paper and smoking material, for example tobacco, are commercially available. However, manual cigarette preparation, also known as cigarette rolling, can be in some instances uncomfortable, for example while rolling cigarettes outdoors; or even not practical, for example for cigarette consumers that are unable to roll cigarettes by themselves, for example due to medical limitations like finger disability or shivering of the hand and fingers. Moreover, there is an increasing need for self-preparation of cigarettes for medical purposes, for example smoking of medicinal smoke materials, like leaves and flowers of cannabis plants.

### SUMMARY

Unless otherwise defined, all technical and scientific terms used herein have the same meaning as commonly understood by one of ordinary skill in the art to which this subject matter belongs. Although methods and materials similar or equivalent to those described herein can be used in the practice or testing of the present subject matter, suitable methods and materials are described below. In case of conflict, the patent specification, including definitions, will control. In addition, the materials, methods, and examples are illustrative only and not intended to be limiting.

According to one aspect of the present subject matter, there is provided a cigarette preparation device comprising: a chopping module configured to chop smoke material for preparing chopped smoke material; and a rolling module coupled to the chopping module, configured to roll cigarettes with cigarette paper and chopped smoke material.

According to one embodiment, the chopping module is releasably coupled to the rolling module.

According to another embodiment, the chopping module comprising at least one blade configured to chop smoke material, coupled to a chopping motor configured to actuate the at least one blade.

According to yet another embodiment, the chopping motor is an electrical chopping motor.

According to still another embodiment, the cigarette preparation device comprising a power source electrically connected to the chopping motor, and configured to supply electrical power to the chopping motor.

According to a further embodiment, the cigarette preparation device comprising a chopping module housing defining an interior of the chopping module and configured to serve as a housing for components of the chopping module in the interior of the chopping module.

According to yet a further embodiment, at least part of the chopping module housing is openable, and the chopping module is configured to be in an open state and in a closed state.

According to still a further embodiment, the rolling module comprising a rolling mechanism configured to roll cigarettes by using cigarette paper sheets and chopped smoke material.

According to one embodiment, the rolling mechanism is coupled to a rolling motor configured to actuate the rolling mechanism.

According to another embodiment, the rolling mechanism comprising multiple cylinders, each cylinder is configured to rotate about its longitudinal axis in coordination with other cylinders.

According to yet another embodiment, the rolling module comprising a rolling module housing defining an interior of the rolling module and configured to serve as a housing for components of the rolling module in the interior of the rolling module.

According to still another embodiment, at least part of the rolling module housing is openable, and the rolling module is configured to be in an open state and in a closed state.

According to another aspect of the present subject matter, there is provided a method for chopping a smoke material with the cigarette preparation device described herein, the method comprising:
providing the cigarette preparation device;
removing a cover of a chopping module of the cigarette preparation device;
inserting a smoke material into the chopping module through a blade opening that was covered by the cover;
covering back the blade opening with the cover;
pressing a switch of the chopping module for actuating a chopping motor;
chopping the smoke material by turning of an at least one blade by the chopping motor, to obtain chopped smoke material;
pressing the switch for turning off the chopping motor;
removing the cover of the chopping module; and
removing the chopped smoke material from the chopping module.

According to yet another aspect of the present subject matter, there is provided a method for rolling a cigarette with the cigarette preparation device described herein, the method comprising:
providing the cigarette preparation device;
opening a rolling module housing of a rolling module of the cigarette preparation device;
inserting chopped smoke material into the rolling module;
closing the rolling module housing;
providing a cigarette paper into the rolling module;
pressing a switch of the rolling module for actuating a rolling motor;
rolling a cigarette by turning cylinders of a rolling mechanism of the rolling module and combining the chopped smoke material and the cigarette paper, to obtain a cigarette;
pressing the switch for turning off the rolling motor;
opening the rolling module housing; and
removing the cigarette from the rolling module.

According to still another aspect of the present subject matter, there is provided a method for preparing a cigarette from a smoke material and cigarette paper with the cigarette preparation device described herein, the method comprising:
providing the cigarette preparation device;
removing a cover of a chopping module of the cigarette preparation device;
inserting a smoke material into the chopping module through a blade opening that was covered by the cover;
covering back the blade opening with the cover;
pressing a switch of the chopping module for actuating a chopping motor;
chopping the smoke material by turning of an at least one blade by the chopping motor, to obtain chopped smoke material;
pressing the switch for turning off the chopping motor;
separating the chopping module from the rolling module;
removing the cover of the chopping module;
opening a rolling module housing of the rolling module;
pouring chopped smoke material from the chopping module into the rolling module;
closing the rolling module housing;
providing a cigarette paper into the rolling module;
pressing a switch of the rolling module for actuating a rolling motor;
rolling a cigarette by turning cylinders of a rolling mechanism of the rolling module and combining the chopped smoke material and the cigarette paper, to obtain a cigarette;
pressing the switch for turning off the rolling motor;
opening the rolling module housing; and
removing the cigarette from the rolling module.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding, the description taken with the drawings making apparent to those skilled in the art how several forms may be embodied in practice.

In the drawings:

FIGS. 1A-B schematically illustrate, according to an exemplary embodiment, perspective views of a cigarette preparation device.

FIGS. 2A-B schematically illustrate, according to an exemplary embodiment, perspective views of a separated chopping module and a separated rolling module, respectively.

FIG. 3 schematically illustrates, according to an exemplary embodiment, a cigarette preparation device in which a chopping module is partially separated from a rolling module.

FIG. 4 schematically illustrates, according to an exemplary embodiment, an exploded view of a chopping module.

FIG. 5 schematically illustrates, according to an exemplary embodiment, an exploded view of a rolling module.

### DESCRIPTION OF THE PREFERRED EMBODIMENTS

Before explaining at least one embodiment in detail, it is to be understood that the subject matter is not limited in its application to the details of construction and the arrangement of the components set forth in the following description or illustrated in the drawings. The subject matter is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts. The drawings are generally not to scale.

For clarity, non-essential elements were omitted from some of the drawings.

“Smoke material” as disclosed herein refers to any material that is suitable for smoking by a human being, for example plant material like leaves, stems, flowers and the like, of plants that are suitable for smoking, like tobacco, cannabis, lettuce, and the like.

The present subject matter provides a cigarette preparation device comprising: a chopping module configured to chop smoke material for preparing chopped smoke material; and a rolling module coupled to the chopping module, configured to roll cigarettes with cigarette paper and chopped smoke material.

The present subject matter further provides methods for chopping a smoke material, rolling a cigarette, and preparing a cigarette with the cigarette preparation device of the present subject matter, as described hereinafter.

The cigarette preparation device is suitable for personal use by an individual willing to self-prepare a cigarette using smoke material of his choice. An advantage of the cigarette preparation device is that it allows preparation of cigarettes from raw smoke material, for example intact leaves, flowers, stems and the like. This feature of the cigarette preparation device provides smoke consumers with the freedom to choose their own smoke material and prepare from it cigarettes. In addition, the rolling module can make cigarettes from chopped smoke material made by the chopping module, or from chopped smoke material from another source, for example, ready-to-use chopped smoke material, like chopped tobacco.

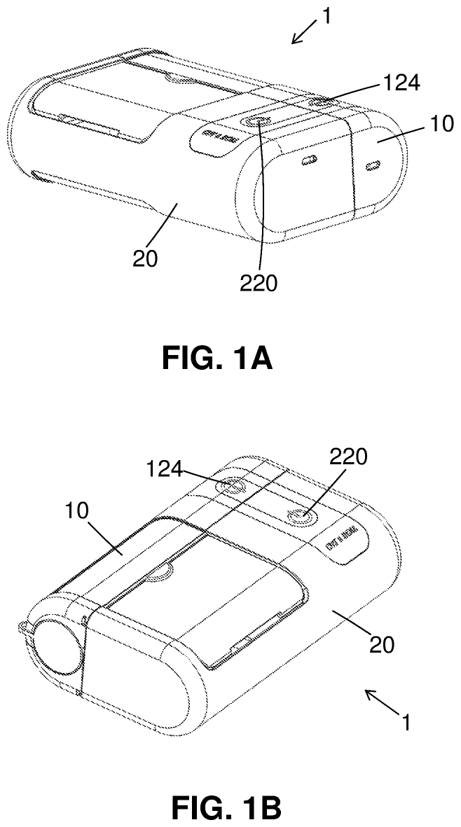

Referring now to FIGS. 1A-B schematically illustrating, according to an exemplary embodiment, perspective views of a cigarette preparation device. According to one embodiment, illustrated in FIGS. 1A-B, the cigarette preparation device 1 comprises a chopping module 10 configured to chop smoke material for preparing chopped smoke material, coupled to a rolling module 20 configured to roll cigarettes with the chopped smoke material.

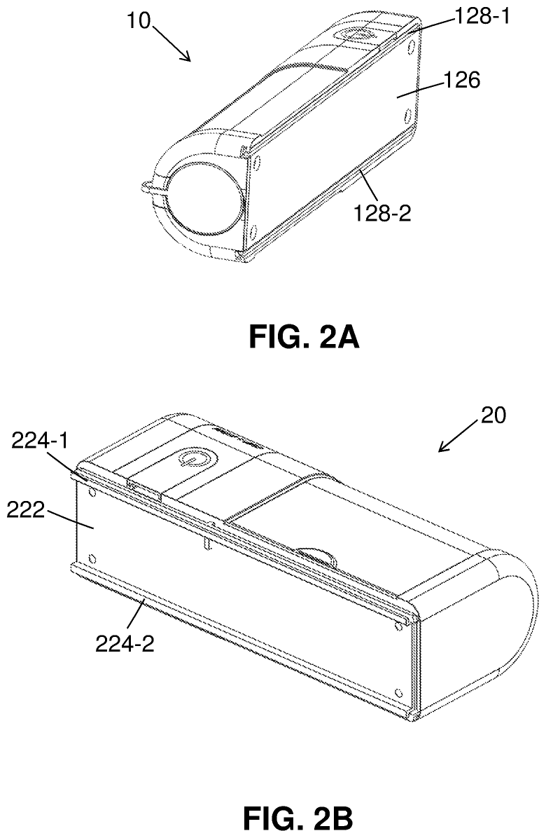

Referring now to FIGS. 2A-B schematically illustrating, according to an exemplary embodiment, perspective views of a separated chopping module and a separated rolling module, respectively. FIG. 2A illustrates a separated chopping module 10, and FIG. 2B illustrates a separated rolling module 20.

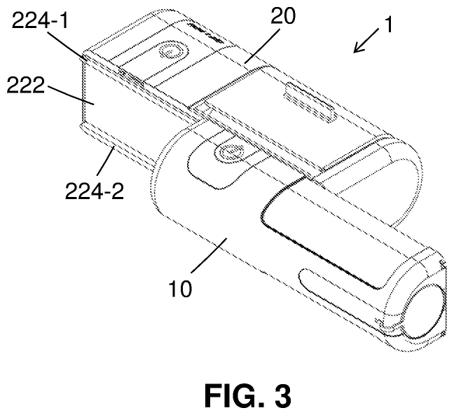

According to embodiment, shown in FIGS. 1A-B, the chopping module 10 and the rolling module 20 are permanently coupled one to the other. According to another embodiment, the chopping module 10 and the rolling module 20 are configured to separate one from the other, as illustrated in FIGS. 2A-B that show the chopping module 10 and the rolling module 20, respectively, that are separated one from the other. The chopping module 10 and the rolling module 20 can be coupled one to the other by any mechanism, for example adhering, welding and the like, when the chopping module 10 and the rolling module 20 are permanently coupled; or by releasable coupling when the chopping module 10 and the rolling module 20 are configured to separate one from the other. An exemplary releasable coupling of the chopping module 10 with the rolling module 20 is illustrated in FIG. 3 hereinafter.

Referring now to FIG. 3 schematically illustrating, according to an exemplary embodiment, a cigarette preparation device in which a chopping module is partially separated from a rolling module. FIG. 3 illustrates an exemplary embodiment of a releasable coupling mechanism of the chopping module 10 and the rolling module 20. According one embodiment, the chopping module 10 is slidably coupled to the rolling module 20.

Returning now to FIGS. 2A-B. According to one embodiment, the chopping module 10 comprises at least one chopping rail 128 as can be seen in FIG. 2A, and the rolling module 20 comprises at least one rolling rail 224 as can be seen in FIG. 2B, that corresponds to the at least one chopping rail 128, in a manner that allows sliding of the at least one chopping rail 128 along the at least one rolling rail 224, as shown in FIG. 3. For example, as illustrated in FIG. 2A, the chopping module 10 comprises two chopping rails 128—a first chopping rail 128-1 and a second chopping rail 128-2; and as illustrated in FIG. 2B, the rolling module 20 comprises two rolling rail 224—a first rolling rail 224-1 and a second rolling rail 224-2. The first chopping rail 128-1 corresponds to the first rolling rail 124-1, and the second chopping rail 124-2 corresponds to the second rolling rail 224-2.

To summarize, the chopping module 10 can be coupled to the rolling module 20, either permanently, or releasably, as illustrated in FIGS. 1A-B. When releasably coupled, the chopping module 10 can separate from the rolling module 20, as illustrated in FIGS. 2A-B. FIG. 3 illustrates an exemplary mechanism of releasable coupling of the chopping module 10 with the rolling module 20, by at least one chopping rail 128 that corresponds to at least one rolling rail 224.

Returning now to FIGS. 2A-B. According to one embodiment, the chopping module 10 comprises a chopping wall 126, as can be seen in FIG. 2A. According to another embodiment, the rolling module 20 comprises a rolling wall 222. It should be noted that when the chopping module 10 comprises a chopping wall 126, there is no necessity that the rolling module 20 will comprise a rolling wall 222; or when the rolling module 20 comprises a rolling wall 222 there is no necessity that the chopping module 10 will comprise a chopping wall 126. Preferably, both modules comprise a wall—the chopping module 10 comprises a chopping wall 126 and the rolling module 20 comprises a rolling wall 222.

Another embodiment that is shown in FIG. 2A is that the at least one chopping rail 128 is adjacent to the chopping wall 126. Yet another embodiment that is shown in FIG. 2B is that the at least one rolling rail 224 is adjacent to the rolling wall 222.

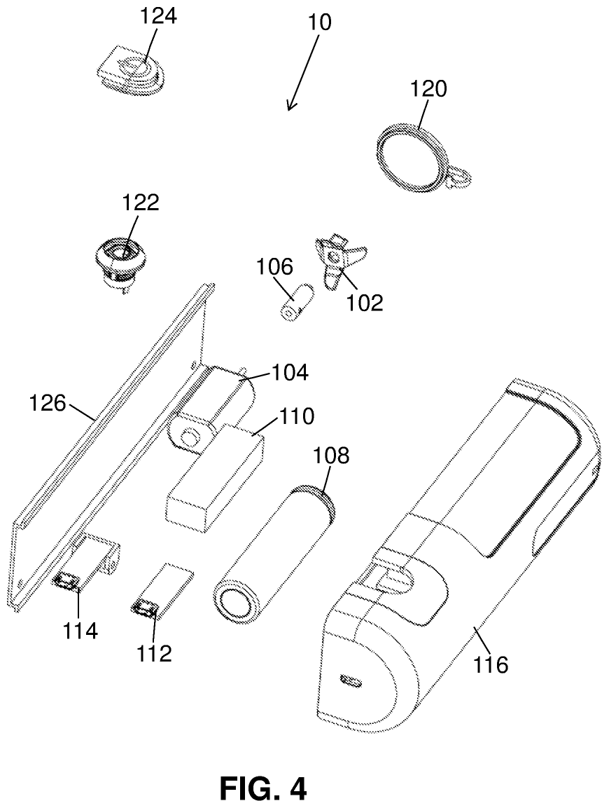

Referring now to FIG. 4 schematically illustrating, according to an exemplary embodiment, an exploded view of a chopping module. FIG. 4 illustrates components of the chopping module 10.

According to one embodiment, the chopping module 10 comprises at least one blade 102 configured to chop smoke material. The at least one blade 10 is coupled to a chopping motor 104, preferably an electrical chopping motor 104, configured to actuate the at least one blade 102. For example, the at least one blade 102 is rotatable, and the chopping motor 104 is configured to rotate the at least one blade 102. According to one embodiment, the at least one blade 102 is directly coupled to the chopping motor 104. According to another embodiment, the at least one blade 102 is coupled to the chopping motor 104 with a coupling element 106 configured to transmit actuating power from the chopping motor 104 to the at least one blade 102. Any type of coupling element 106 is under the scope of the present subject matter, for example a shaft 106, as can be seen in FIG. 4.

In an embodiment of an electrical chopping motor 104, the chopping module 10 further comprises a power source 108 electrically connected to the chopping motor 104, and configured to supply electrical power to the chopping motor 104. Any power source 108 known in the art is under the scope of the present subject matter, for example, a disposable battery, a rechargeable battery, and the like.

According to one embodiment, the chopping module 10 further comprises a boost converter 110, also known as step-up converter, electrically connected between the power source 108 and the chopping motor 104, and configured to increase voltage while decreasing current of an electrical power that is supplied from the power source 108 to the chopping motor 104.

According to one embodiment, the power source 108 is a rechargeable power source 108. Thus, accordingly, the chopping module 10 can further comprise a charging circuit 112 electrically connected to the rechargeable power source 108. In one hand, the charging circuit 112 is configured to be electrically connected to an external power source, for example the mains via an electric plug configured to be connected to a mains socket, or to a computer, a power bank, and the like, for example via a USB connection. The charging circuit 112 is configured to charge the rechargeable power source 108 with electrical power from the external power source.

According to one embodiment, the chopping module 10 further comprises a charging circuit support 114 configured to support the charging circuit 112 and hold the charging circuit 112 in place.

According to one embodiment, the chopping module 10 further comprises a chopping module housing 116 defining an interior of the chopping module 10 and configured to serve as a housing for the components of the chopping module 10 in the interior of the chopping module 10.

According to one embodiment, at least part of the chopping module housing 116 is openable. Thus, the chopping module 10 is configured to be in an open state and in a closed state. The open state of the chopping module 10 allows insertion of smoke material into the interior of the chopping module 10, and removal of chopped smoke material from the interior of the chopping module 10. It should be mentioned that the smoke material is chopped in the interior of the chopping module 10.

According to one embodiment, the chopping module 10 further comprises a blade opening in the chopping module housing 116 positioned adjacent to the at least one blade 102, and configured to allow insertion of smoke material into the interior of the chopping module 10 in a manner that allows passage of the smoke material through the at least one blade 102, while the at least one blade 102 is actuated, for example rotating. Thus, according to this embodiment, the smoke material can be chopped by the at least one blade 102 while inserted into the interior of the chopping module 10.

According to one embodiment, the chopping module 10 further comprises a cover 120 configured to removably cover the blade opening, for example in order to prevent entry of unwanted material, for example dirt, into the interior of the chopping module 10.

According to one embodiment, the chopping module 10 further comprises a switch 122 configured to switch on and switch off the chopping motor 104, for example by pressing the switch 122. Any mechanism for switching on and switching off a chopping motor 104 is under the scope of the present subject matter, for example a switch 122 that is configured to open and close an electrical circuit connecting the power source 108 with the chopping motor 104. According to another embodiment, the switch 122 is exposed on an outer surface of the chopping module housing 116 in order to allow access to the switch 122, for example, for a finger of a user to press the switch 122.

According to one embodiment, the chopping module 10 further comprises a switch cover 124, also shown for example in FIGS. 1A-B for example. The switch cover 124 is configured to cover the switch 122 and allow easy pressing of the switch 122. According to a preferred embodiment, the switch cover 124 is made of a soft material, for example silicon, soft plastic and the like.

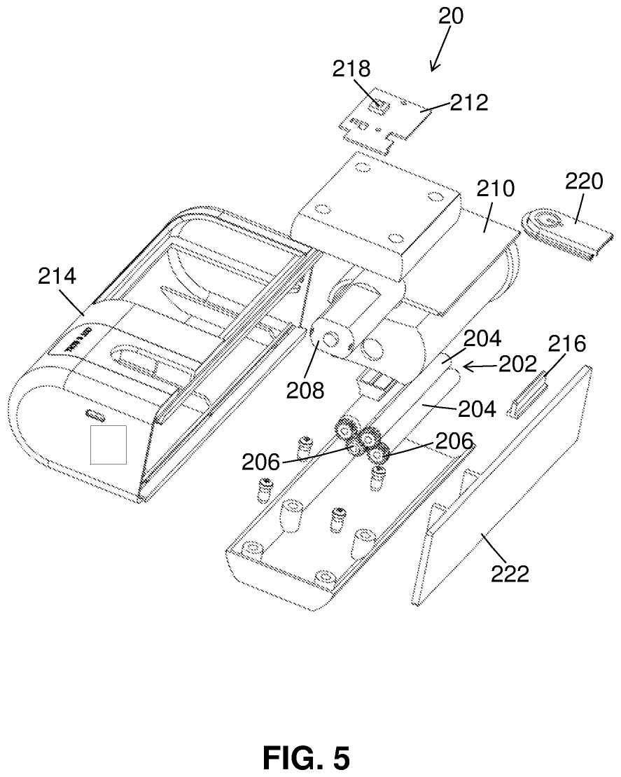

Referring now to FIG. 5 schematically illustrating, according to an exemplary embodiment, an exploded view of a rolling module. FIG. 5 illustrates components of the rolling module 10.

According to one embodiment, the rolling module 20 comprises a rolling mechanism 202 configured to roll cigarettes by using cigarette paper sheets and chopped smoke material. According to one embodiment, the rolling mechanism 202 comprises multiple cylinders 204, each cylinder 204 is configured to rotate about its longitudinal axis in coordination with other cylinders 204. This can be achieved, for example, by a gear 206 attached to an end of the cylinder 204, wherein gears 206 of the cylinders 204 are integrated one with the other, as can be seen in FIG. 5, in a manner that rolling of one cylinder 204 about its longitudinal axis forces rotation of each of the other cylinders 204 about its longitudinal axis. When the cylinders 204 roll about their longitudinal axes they are configured to pass cigarette paper sheets and chopped smoke material in-between, thereby rolling the cigarette paper sheets and the chopped smoke material to make cigarettes.

According to one embodiment, the rolling mechanism 202 is coupled to a rolling motor 208 configured to actuate the rolling mechanism 202. According to another embodiment, one of the cylinders 204 is coupled to the rolling motor 208, and the rolling motor is configured to rotate the cylinder 204 to which it is coupled about its longitudinal axis. According to a preferred embodiment, the rolling motor 208 is an electrical rolling motor 208. Thus, as described above, rolling of the cylinder 204 about its longitudinal axis by the rolling motor 208 causes all the other cylinders 204 of the rolling mechanism 202 to rotate, each about its longitudinal axis.

According to one embodiment, the rolling module 20 further comprises a power source 210 electrically connected to the rolling motor 208, and configured to supply electrical power to the rolling motor 208. Any power source 210 is under the scope of the present subject matter, for example, a disposable battery, a rechargeable battery, and the like.

According to one embodiment, the power source 210 is a rechargeable power source 210. Thus, accordingly, the rolling module 20 can further comprise a charging circuit 212 electrically connected to the rechargeable power source 210. In one hand, the charging circuit 212 is configured to be electrically connected to an external power source, for example the mains via an electric plug configured to be connected to a mains socket, or to a computer, a power bank, and the like, for example via USB connection. The charging circuit 212 is configured to charge the rechargeable power source 210 with electrical power from the external power source.

According to one embodiment, the rolling module 20 comprises a rolling module housing 214 defining an interior of the rolling module 20 and configured to serve as a housing for the components of the rolling module 20 in the interior of the rolling module 20.

According to one embodiment, at least part of the rolling module housing 214 is openable. Thus, the rolling module 20 is configured to be in an open state and in a closed state. The open state of the rolling module 20 allows insertion of cigarette paper sheets and chopped smoke material into the interior of the rolling module 20, and removal of rolled cigarettes from the interior of the rolling module 20.

According to one embodiment, the rolling module 20 further comprises a handle 216 configured to allow convenient opening and closing of the at least part of the rolling module housing 214 that is openable.

According to one embodiment, the rolling module 20 further comprises a switch 218 configured to switch on and switch off the rolling motor 208, for example by pressing the switch 218. Any mechanism for switching on and switching off a rolling motor 208 is under the scope of the present subject matter, for example a switch 218 that is configured to open and close an electrical circuit connecting the power source 210 with the rolling motor 208. According to another embodiment, the switch 218 is exposed on an outer surface of the chopping module housing 214 in order to allow access to the switch 218, for example, for a finger of a user to press the switch 218.

According to one embodiment, the rolling module 20 further comprises a switch cover 220, also shown for example in FIGS. 1A-B. The switch cover 220 is configured to cover the switch 218 and allow easy pressing of the switch 218. According to a preferred embodiment, the switch cover 220 is made of a soft material, for example silicon, soft plastic and the like.

As mentioned above, according to one embodiment, the chopping module 10 is configured to be separated from the rolling module 20, for example in order to transfer chopped smoke material from the chopping module 10 to the rolling module 20. Thus, according to this embodiment, the chopping module 10 is releasably coupled to the rolling module 20.

The present subject matter further provides a method for chopping a smoke material with the cigarette preparation device 1 of the present subject matter, the method comprising:
providing a cigarette preparation device 1, as described herein;
removing a cover 120 of a chopping module 10 of the cigarette preparation device 1;
inserting a smoke material into the chopping module 10 through a blade opening that was covered by the cover 120;
covering back the blade opening with the cover 120;
pressing a switch 122 of the chopping module 10 for actuating a chopping motor 104;
chopping the smoke material by turning of an at least one blade 102 by the chopping motor 104, to obtain chopped smoke material;
pressing the switch 122 for turning off the chopping motor 104;
removing the cover 120 of the chopping module 10; and
removing the chopped smoke material from the chopping module 10.

The present subject matter additionally provides a method for rolling a cigarette with the cigarette preparation device 1 of the present subject matter, the method comprising:
providing a cigarette preparation device 1, as described herein;
opening a rolling module housing 214 of a rolling module 20 of the cigarette preparation device 1;
inserting chopped smoke material into the rolling module 20;
closing the rolling module housing 214;
providing a cigarette paper into the rolling module 20;
pressing a switch 218 of the rolling module 20 for actuating a rolling motor 208;
rolling a cigarette by turning cylinders 204 of a rolling mechanism 202 of the rolling module 20 and combining the chopped smoke material and the cigarette paper, to obtain a cigarette;
pressing the switch 218 for turning off the rolling motor 208;
opening the rolling module housing 214; and removing the cigarette from the rolling module 20.

The present subject matter further provides a method for preparing a cigarette from a smoke material and cigarette paper with the cigarette preparation device 1 of the present subject matter, the method comprising:
providing a cigarette preparation device 1, as described herein;
removing a cover 120 of a chopping module 10 of the cigarette preparation device 1;
inserting a smoke material into the chopping module 10 through a blade opening that was covered by the cover 120;
covering back the blade opening with the cover 120;
pressing a switch 122 of the chopping module 10 for actuating a chopping motor 104;
chopping the smoke material by turning of an at least one blade 102 by the chopping motor 104, to obtain chopped smoke material;
pressing the switch 122 for turning off the chopping motor 104;
separating the chopping module 10 from the rolling module 20;
removing the cover 120 of the chopping module 10;
opening a rolling module housing 214 of the rolling module 20;
pouring chopped smoke material from the chopping module 10 into the rolling module 20;
closing the rolling module housing 214;
providing a cigarette paper into the rolling module 20;
pressing a switch 218 of the rolling module 20 for actuating a rolling motor 208;
rolling a cigarette by turning cylinders 204 of a rolling mechanism 202 of the rolling module 20 and combining the chopped smoke material and the cigarette paper, to obtain a cigarette;
pressing the switch 218 for turning off the rolling motor 208;
opening the rolling module housing 214; and removing the cigarette from the rolling module 20.

One advantage of the cigarette preparation device 1 of the present subject matter is that it provides a single device that is configured both to chop smoke material to provide smoked chopped material, and roll a cigarette with the chopped smoke material and cigarette paper. Thus, the cigarette preparation device 1 of the present subject matter performs all the steps of a preparation of a cigarette from raw un-chopped smoke material and cigarette paper.

It is appreciated that certain features of the subject matter, which are, for clarity, described in the context of separate embodiments, may also be provided in combination in a single embodiment. Conversely, various features of the subject matter, which are, for brevity, described in the context of a single embodiment, may also be provided separately or in any suitable sub combination.

Although the subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A cigarette preparation device comprising:
a chopping module configured to chop smoke material for preparing chopped smoke material; and
a rolling module coupled to the chopping module, configured to roll cigarettes with cigarette paper and chopped smoke material.

2. The cigarette preparation device of claim 1, wherein the chopping module is releasably coupled to the rolling module.

3. The cigarette preparation device of claim 1, wherein the chopping module comprising at least one blade configured to chop smoke material, coupled to a chopping motor configured to actuate the at least one blade.

4. The cigarette preparation device of claim 3, wherein the chopping motor is an electrical chopping motor.

5. The cigarette preparation device of claim 4 comprising a power source electrically connected to the chopping motor, and configured to supply electrical power to the chopping motor.

6. The cigarette preparation device of claim 1 comprising a chopping module housing defining an interior of the chopping module and configured to serve as a housing for components of the chopping module in the interior of the chopping module.

7. The cigarette preparation device of claim 6, wherein at least part of the chopping module housing is openable, and the chopping module is configured to be in an open state and in a closed state.

8. The cigarette preparation device of claim 1, wherein the rolling module comprising a rolling mechanism configured to roll cigarettes by using cigarette paper sheets and chopped smoke material.

9. The cigarette preparation device of claim 8, wherein the rolling mechanism is coupled to a rolling motor configured to actuate the rolling mechanism.

10. The cigarette preparation device of claim 8, wherein the rolling mechanism comprising multiple cylinders, each cylinder is configured to rotate about its longitudinal axis in coordination with other cylinders.

11. The cigarette preparation device of claim 1, wherein the rolling module comprising a rolling module housing defining an interior of the rolling module and configured to serve as a housing for components of the rolling module in the interior of the rolling module.

12. The cigarette preparation device of claim 11, wherein at least part of the rolling module housing is openable, and the rolling module is configured to be in an open state and in a closed state.

13. A method for chopping a smoke material with the cigarette preparation device of claim 1, the method comprising:
providing the cigarette preparation device;
removing a cover of a chopping module of the cigarette preparation device; inserting a smoke material into the chopping module through a blade opening that was covered by the cover;
covering back the blade opening with the cover;
pressing a switch of the chopping module for actuating a chopping motor; chopping the smoke material by turning of an at least one blade by the chopping motor, to obtain chopped smoke material;
pressing the switch for turning off the chopping motor;
removing the cover of the chopping module; and
removing the chopped smoke material from the chopping module.

14. A method for rolling a cigarette with the cigarette preparation device of claim 1, the method comprising:
providing the cigarette preparation device;
opening a rolling module housing of a rolling module of the cigarette preparation device;
inserting chopped smoke material into the rolling module;
closing the rolling module housing;
providing a cigarette paper into the rolling module;
pressing a switch of the rolling module for actuating a rolling motor;
rolling a cigarette by turning cylinders of a rolling mechanism of the rolling module and combining the chopped smoke material and the cigarette paper, to obtain a cigarette;
pressing the switch for turning off the rolling motor;
opening the rolling module housing; and
removing the cigarette from the rolling module.

15. A method for preparing a cigarette from a smoke material and cigarette paper with the cigarette preparation device of claim 1, the method comprising: providing the cigarette preparation device;
removing a cover of a chopping module of the cigarette preparation device; inserting a smoke material into the chopping module through a blade opening that was covered by the cover;
covering back the blade opening with the cover;
pressing a switch of the chopping module for actuating a chopping motor; chopping the smoke material by turning of an at least one blade by the chopping motor, to obtain chopped smoke material;
pressing the switch for turning off the chopping motor;
separating the chopping module from the rolling module;
removing the cover of the chopping module;
opening a rolling module housing of the rolling module;
pouring chopped smoke material from the chopping module into the rolling module;
closing the rolling module housing;
providing a cigarette paper into the rolling module;
pressing a switch of the rolling module for actuating a rolling motor;
rolling a cigarette by turning cylinders of a rolling mechanism of the rolling module and combining the chopped smoke material and the cigarette paper, to obtain a cigarette;
pressing the switch for turning off the rolling motor;
opening the rolling module housing; and
removing the cigarette from the rolling module.
